(19) United States
(12) Patent Application Publication
(10) Pub. No.: US 2026/0302983 A1
(43) Pub. Date: Oct. 1, 2026

(54) ROBUST PREDICTIVE CURRENT CONTROL METHOD FOR SYNCHRONOUS MOTOR WITH SYNCHRONOUS SPACE VECTOR MODULATION

(71) Applicant: North China University of Technology, Beijing (CN)

(72) Inventors: Haitao YANG, Beijing (CN); Yongchang ZHANG, Beijing (CN); Guofeng YUAN, Beijing (CN); Xiaoguang ZHANG, Beijing (CN); Hu ZHANG, Beijing (CN); Zeting WANG, Beijing (CN)

(73) Assignee: North China University of Technology, Beijing (CN)

(21) Appl. No.: 19/221,574

(22) Filed: May 29, 2025

(30) Foreign Application Priority Data
Mar. 27, 2025 (CN) 202510376763.4

(51) Int. Cl. H02P 21/22; H02P 21/13; H02P 21/14

(52) U.S. Cl. CPC H02P 21/22; H02P 21/13; H02P 21/14

(57) ABSTRACT

A robust predictive current control method for synchronous motor with synchronous space vector modulation includes the following steps: S1, updating the estimated value of the disturbance voltage at the previous sampling time; S2, calculating the estimated value of the disturbance voltage at the current sampling time, and predicting the observed value of the stator current of the synchronous motor at the next sampling time; S3, calculating the voltage drop of the stator winding of the synchronous motor at the next sampling time, and calculating the observed value of the disturbance voltage at the next sampling time; S4, mapping the voltage command phase to the discrete sampling point preset by SSVM; S5, aligning the voltage command to the sampling point of SSVM; S6, generating the voltage command; S7, obtaining the SSVM pulse. The control method can adapt to the sampling interval change of SSVM under low carrier ratio operating conditions.

### CROSS REFERENCE TO THE RELATED APPLICATIONS

This application is based upon and claims priority to Chinese Patent Application No. 202510376763.4, filed on Mar. 27, 2025, the entire contents of which are incorporated herein by reference.

### TECHNICAL FIELD

The invention relates to the field of motor operation control technology, in particular to a robust predictive current control method for synchronous motor with synchronous space vector modulation.

### BACKGROUND

In high-power and high-speed permanent magnet synchronous motor drive systems, inverters usually operate at low carrier ratio conditions. Under this condition, synchronous space vector modulation (SSVM) has become a very suitable modulation method because of its advantages of small current harmonics, no current ripple at the sampling point, and the ability to generate driving pulses in real time online. However, when phase synchronization or mode switching is achieved in the dynamic process, the sampling interval of SSVM may change significantly. The traditional control strategy is usually designed based on a fixed control period, which makes it challenging to adapt to this significant sampling interval change, resulting in slow phase synchronization and poor dynamic performance of the current loop in the control system based on SSVM.

Especially under the condition of a low carrier ratio, the existing schemes mostly adopt complex vector digital current regulators. In order to maintain the stability margin of the system under large control delay, the bandwidth of the current loop is limited to a low level, which makes the dynamic response speed of the system slow. In addition, in order to ensure that the inverter can output the symmetrical voltage pulse required by SSVM in quasi-steady state operation, the voltage phase of the controller must be consistent with the preset sampling position of SSVM. However, in the dynamic process, the controller may arbitrarily adjust the amplitude and phase of the voltage command as needed to eliminate the current tracking error, which may lead to a deviation between the phase of the voltage command and the preset sampling point of SSVM.

Given the above problems, some control step adjustment methods based on phase-locked loop (PLL) or error feedforward are proposed in the existing literature to realize phase compensation. However, in order to avoid adverse effects on the current loop, the phase synchronization speed of these methods is usually limited, and it is difficult to meet the needs of fast dynamic response. On the other hand, deadbeat predictive current control (DPCC) has attracted much attention due to its simple principle and fast dynamic response.

However, the traditional DPCC is sensitive to motor parameters and external disturbances, when the motor parameters deviate from the nominal value, it may lead to steady-state tracking error. In order to improve the parameter robustness of DPCC, the disturbance observer is widely used in the existing literature. However, the traditional DPCC and its disturbance observer are usually designed based on a fixed control period, therefore, when the SSVM adjusts the sampling interval significantly due to modulation mode switching and elimination of current tracking error, the system may present a large current spike, which will affect the overall performance.

### SUMMARY

The purpose of the invention is to provide a robust predictive current control method for synchronous motor with synchronous space vector modulation to solve the above technical problems.

In order to achieve the above purpose, the invention provides a robust predictive current control method for synchronous motor with synchronous space vector modulation, including the following steps:
S1, according to a current observation error at a current sampling time, estimating a disturbance voltage deviation, and updating an estimated value of the disturbance voltage at a previous sampling time based on the estimated disturbance voltage deviation;
S2, based on the estimated value of the disturbance voltage at the previous sampling time obtained by S1, calculating the estimated value of the disturbance voltage at the current sampling time, and based on the estimated value of the disturbance voltage at the current sampling time, predicting an observed value of a stator current of a synchronous motor at the next sampling time to compensate a digital delay;
S3, based on the observed value of the stator current of the synchronous motor at the next sampling time obtained by S2, calculating a voltage drop of a stator winding of the synchronous motor at the next sampling time, and calculating an observed value of the disturbance voltage at the next sampling time based on the estimated value of the disturbance voltage at the current sampling time obtained by S2;
S4, based on the voltage drop and the observed value of the disturbance voltage of the stator winding of the synchronous motor at the next sampling time obtained by S3, predicting a voltage command phase at the next sampling time, and calculating a preset sampling position adjacent to the voltage command phase at the next sampling time, so that a motor command phase is mapped to a discrete sampling point preset by SSVM;
S5, based on the voltage command phase calculated by S4 and the preset sampling position, calculating a sampling interval of a next control period, so that the voltage command phase can be aligned with the sampling points of SSVM by adjusting the control period;
S6, generating a voltage command based on the sampling interval of the next control period calculated based on S5;
S7, based on the voltage command obtained by S6, calculating a duty ratio of each basic voltage vector to obtain SSVM pulses.

Preferably, in S1, an estimation formula of the disturbance voltage deviation is:

$$Δ {u}_{d}^{k - 1} = ( {λ}_{1} {e}^{j {ω}_{e} {T}_{sc}^{k - 1}} Δ {i}_{s}^{k - 1} - Δ {i}_{s}^{k} ) / {c}_{3}^{k - 1}$$

where

$$Δ {u}_{d}^{k - 1}$$

denotes a disturbance voltage deviation at the sampling time k−1; λ₁ denotes an error feedback gain of an observer; j denotes an imaginary unit;

$${T}_{sc}^{k - 1}$$

denotes a sampling interval at the sampling time k−1; ωₑ denotes an electrical speed of a synchronous motor rotor;

$$Δ {i}_{S}^{k - 1} and Δ {i}_{S}^{k}$$

denote current observation errors at the a synchronous motor rotor; sampling time k−1 and the current sampling time K respectively, and

$$Δ {i}_{S}^{k} = {i}_{S}^{k} - {\hat{i}}_{S}^{k} , {i}_{S}^{k}$$

denotes a stator current value of the synchronous motor at the current sampling time k measured by a current sensor, and

$${\hat{i}}_{S}^{k}$$

denotes a stator current value of the synchronous motor at the current sampling time K observed by the observer;

$${c}_{3}^{k - 1}$$

denotes an observer model parameter at the sampling time k−1;
where

$${c}_{3}^{k - 1} = \frac{{e}^{j {ω}_{e} {T}_{sc}^{k - 1}} - {e}^{- {T}_{sc}^{k - 1} / {τ}_{s}}}{{R}_{s} ( 1 + j {ω}_{e} {τ}_{s} )}$$

where Rₛ denotes a nominal value of a stator resistance of the synchronous motor; τₛ denotes the nominal value of a stator time constant of the motor;
an updated calculation formula of the estimated value

$${\hat{u}}_{d}^{k - 1}$$

of the disturbance voltage is as follows:

$${\hat{u}}_{d}^{k - 1} = {e}^{j {ω}_{e} {T}_{sc}^{k - 2}} {\hat{u}}_{d}^{k - 2} + ( 1 - {λ}_{2} ) / {λ}_{2} Δ {u}_{d}^{k - 1}$$

where

$${T}_{sc}^{k - 2}$$

denotes a sampling interval of the control period at the sampling time k−2;

$${\hat{u}}_{d}^{k - 2}$$

denotes an observed value of the disturbance voltage at the sampling time k−2; λ₂ denotes an integral calculation gain of the disturbance voltage, and 0<λ₂<1.

Preferably, in S2, a calculation formula of the estimated value

$${\hat{u}}_{d}^{k}$$

of the disturbance voltage at the current sampling time k is as follows:

$${\hat{u}}_{d}^{k} = {\hat{u}}_{d}^{k - 1} {e}^{j {ω}_{e} {T}_{sc}^{k - 1}}$$

a prediction calculation formula of the current observation value

$${\hat{i}}_{s}^{k + 1}$$

of the synchronous motor stator is as follows:

$${\hat{i}}_{s}^{k + 1} = {c}_{1}^{k} {\hat{i}}_{s}^{k} + {c}_{2}^{k} {u}_{s}^{k} - {c}_{3}^{k} ( {\hat{u}}_{d}^{k} + {E}_{d}^{k} ) - {λ}_{1} {e}^{j {ω}_{e} {T}_{sc}^{k}} Δ {i}_{s}^{k}$$

where

$${c}_{1}^{k} , {c}_{2}^{k} and {c}_{3}^{k}$$

denote the observer model parameters at the current sampling time k, and

$${c}_{1}^{k} = {e}^{- {T}_{sc}^{k} / {τ}_{s}} , {c}_{2}^{k} = ( 1 - {c}_{1}^{k} ) / {R}_{s} ; {E}_{d}^{k}$$

denotes a back, electromotive force at the current sampling time k, and

$${E}_{d}^{k} = j {ω}_{e} {ψ}_{r} {e}^{j {θ}_{r}^{k}} , {θ}_{r}^{k}$$

denotes measured values of a rotor position of the synchronous motor at the current sampling time k, and ψᵣ denotes a permanent magnet flux linkage of the synchronous motor rotor;

$${u}_{s}^{k}$$

denotes a voltage vector of an inverter output to a stator end of the motor at the current sampling time k;

$${T}_{sc}^{k}$$

denotes a sampling interval of the control period at the current sampling time k.

Preferably, in S3, a calculation formula for the voltage drop

$${u}_{i}^{k + 1}$$

of the stator winding of the synchronous motor at the sampling time k+1 is as follows:

$${u}_{i}^{k + 1} = {R}_{s} ( 1 + j {ω}_{e} {τ}_{s} ) {î}_{s}^{k + 1}$$

a calculation formula of the observed value

$${û}_{d}^{k + 1}$$

of the disturbance voltage at the sampling time k+1 is as follows:

$${û}_{d}^{k + 1} = {û}_{d}^{k} {e}^{j {ω}_{e} {T}_{sc}^{k}}$$

Preferably, in S4, a prediction formula of the voltage command phase

$${θ}_{u 0}^{k + 1}$$

at the sampling time k+1 is as follows:

$${θ}_{u 0}^{k + 1} = \frac{π}{6 N} + ∠ ( {u}_{i}^{k + 1} + {E}_{d}^{k + 1} + {û}_{d}^{k + 1} )$$

where N denotes a count of sampling points in a [0-60°) sector of a selected synchronous modulation strategy;

$${E}_{d}^{k + 1}$$

denotes a back electromotive force at the sampling time k+1, and

$${E}_{d}^{k + 1} = {E}_{d}^{k} {e}^{j {ω}_{e} {T}_{sc}^{k}} ;$$

a calculation formula of a preset sampling position rᵤ is as follows:

$${r}_{u} = round ( 3 N ( {θ}_{u 0}^{k + 1} - {θ}_{0} ) / π )$$

where round( ) denotes rounding to a nearest integer; θ₀ denotes a first sampling position of the synchronous modulation strategy in the [0-60°) sector.

Preferably, a calculation formula of the sampling interval

$${T}_{s c}^{k + 1}$$

of the control period in S5 is as follows:

$${T}_{s c}^{k + 1} = \frac{π}{3 N {ω}_{e}} + \frac{{r}_{u} π / ( 3 N ) + {θ}_{0} - {θ}_{u 0}^{k + 1}}{{ω}_{e}}$$

Preferably, a generation formula of the voltage command

$${u}_{s}^{ref}$$

described in S6 is as follows:

$${u}_{s}^{ref} = \frac{1}{{c}_{2}^{k + 1}} \{ {i}_{s}^{ref} - {c}_{1}^{k + 1} {î}_{s}^{k + 1} + {c}_{3}^{k + 1} ( {E}_{d}^{k} + {û}_{d}^{k} ) {e}^{j {ω}_{e} {T}_{s c}^{k}} \} ;$$

where

$${c}_{1}^{k + 1} , {c}_{2}^{k + 1} and {c}_{3}^{k + 1}$$

denote the observer model parameters at the sampling time k+1;

$${i}_{s}^{ref}$$

denotes a stator current reference value, and

$${i}_{s}^{ref} = ( {i}_{d}^{ref} + j {i}_{q}^{ref} ) {e}^{j ( {θ}_{r}^{k} + {ω}_{e} {T}_{s c}^{k} + {ω}_{e} {T}_{s c}^{k + 1} )} , {i}_{d}^{ref}$$

denotes an excitation current command

$${i}_{q}^{ref}$$

denotes a torque current command.

Preferably, in S7, a calculation formula of the duty ratio for each basic voltage vector is as follows:

$$\{ \begin{matrix}d x = M sin ( π / 3 - ∠ {u}_{s}^{ref} ) \\ d y = M sin ( ∠ {u}_{s}^{ref} ) \\ {d}_{0} = 1 - d x - d y\end{matrix}$$

where dx and dy denote the duty ratios of two effective voltage vectors respectively; M denotes a modulation ratio, and

$$M = \sqrt{3} \vert \begin{matrix}r e f \\ s\end{matrix} \vert / {u}_{d c} , {u}_{d c}$$

denotes a measured value of direct current (DC) bus voltage;

$$∠ {u}_{s}^{ref}$$

denotes a phase angle of a voltage command

$${u}_{s}^{ref} ;$$

d₀ denotes the duty ratio of a zero vector.

Therefore, the invention adopts the above-mentioned robust predictive current control method for synchronous motor with synchronous space vector modulation, and has the beneficial effects as follows:
1. Based on predictive control and disturbance compensation mechanism, the fast tracking of the current command is realized to meet the needs of high-speed and high-power scenarios.
2. The variable step size adjustment strategy is used to ensure that the voltage phase is strictly synchronized with SSVM to avoid the harmonic problem caused by phase deviation.
3. The combination of disturbance observer and variable step size control reduces the sensitivity to motor parameters.

The following is a further detailed description of the technical scheme of the invention through drawings and implementation examples.

### BRIEF DESCRIPTION OF THE DRAWINGS

FIG. 1 is a flow chart of the robust predictive current control method for synchronous motor with the synchronous space vector modulation;

FIG. 2 is an experimental test waveform of the traditional deadbeat predictive current control when the sampling step is reduced from 500 μs to 250 μs;

FIG. 3 is an experimental test waveform diagram of the invention when the sampling step length is reduced from 500 μs to 250 μs;

FIG. 4 is a stator current harmonic diagram of the invention under the synchronous space vector modulation strategy with a pulse ratio of 5;

FIG. 5 is an experimental test waveform of the traditional vector control when the torque command step changes;

FIG. 6 is an experimental test waveform of the invention when the torque command step changes;

FIGS. 7A-7B are simulation test waveform diagrams when the stator inductance of the motor deviates from the nominal value by 20%, where FIG. 7A is a simulation test waveform without disturbance compensation; FIG. 7B is a simulation test waveform diagram for enabling disturbance compensation;

FIGS. 8A-8B are simulation test waveform diagrams when the flux linkage of the permanent magnet of the motor deviates from the nominal value by 10%; FIG. 8A is a simulation test waveform diagram without disturbance compensation; FIG. 8B is a simulation test waveform diagram for enabling disturbance compensation.

### DETAILED DESCRIPTION OF THE EMBODIMENTS

In order to make the purpose, technical scheme, and advantages of the disclosure of the implementation example of the invention clearer, the implementation example of the invention is further described in detail in combination with the attached drawings and implementation example. It should be understood that the specific implementation example described here is only used to explain the implementation example of the invention, and is not used to limit the implementation examples of the invention. Based on the implementation example in this invention, all other implementation examples obtained by ordinary technicians in this field without making creative labor belong to the scope of protection in this application. Examples of the embodiments are shown in the accompanying figures, where the same or similar labels from beginning to end represent the same or similar components or components with the same or similar functions.

It should be noted that the terms ‘include’ and ‘have’ and any deformation of them are intended to cover non-exclusive inclusion, for example, processes, methods, systems, products, or servers that contain a series of steps or units, not necessarily limited to those steps or units that are clearly listed, but may include other steps or units that are not clearly listed or are inherent to those processes, methods, products or equipment.

The following is a detailed description of the implementation example of the invention in combination with the attached figures.

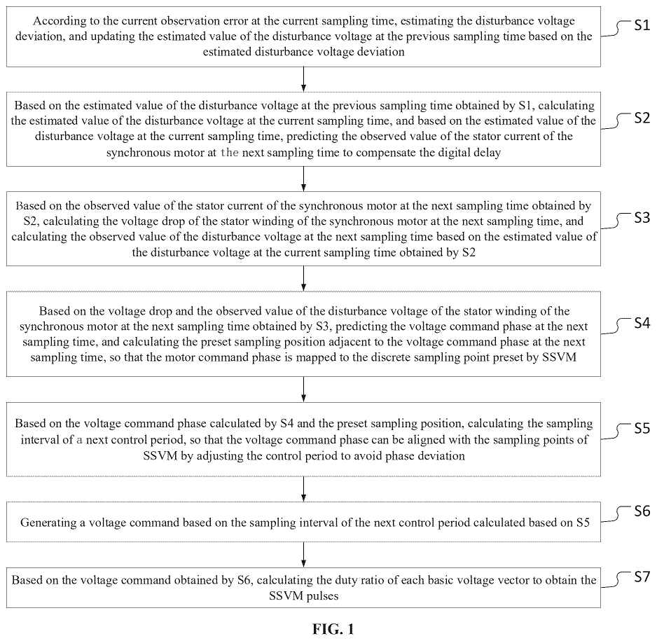

As shown in FIG. 1, a robust predictive current control method for synchronous motors with synchronous space vector modulation (SSVM) includes the following steps:
S1, according to the current observation error at the current sampling time, the disturbance voltage deviation is estimated, and the estimated value of the disturbance voltage at the previous sampling time based on the estimated disturbance voltage deviation is updated;
in S1, the estimation formula of the disturbance voltage deviation is:

$$Δ {u}_{d}^{k - 1} = ( {λ}_{1} {e}^{j {ω}_{e} {T}_{s c}^{k 1}} Δ {i}_{s}^{k - 1} - Δ {i}_{s}^{k} ) / {c}_{3}^{k - 1}$$

where

$$Δ {u}_{d}^{k - 1}$$

denotes the disturbance voltage deviation at the sampling time k−1; λ₁ denotes the error feedback gain of the observer; j denotes the imaginary unit;

$${T}_{sc}^{k - 1}$$

denotes the sampling interval at the sampling time k−1; ωₑ denotes the electrical speed of the synchronous motor rotor;

$$Δ {i}_{s}^{k - 1} and Δ {i}_{s}^{k}$$

denote the current observation errors at the sampling time k−1 and the current sampling time k respectively, and

$$Δ {i}_{s}^{k} = {i}_{{s}^{-}}^{k} {î}_{s}^{k} , {i}_{s}^{k}$$

denotes the stator current value of the synchronous motor at the current sampling time k measured by the current sensor, and

$${î}_{s}^{k}$$

denotes the stator current value of the synchronous motor at the current sampling time k observed by the observer;

$${c}_{3}^{k - 1}$$

denotes the observer model parameter at the sampling time k−1;
where

$${c}_{3}^{k - 1} = \frac{{e}^{j {ω}_{e} {T}_{sc}^{k - 1} - {e}^{- {T}_{sc}^{k - 1} / {τ}_{s}}}}{{R}_{s} ( 1 + j {ω}_{e} {τ}_{s} )}$$

where Rₛ denotes the nominal value of the stator resistance of the synchronous motor; τₛ denotes the nominal value of the stator time constant of the motor;
the updated calculation formula of the estimated value

$${û}_{d}^{k - 1}$$

of the disturbance voltage is as follows:

$${\hat{u}}_{d}^{k - 1} = {e}^{j {ω}_{e} {T}_{s c}^{k - 2}} {\hat{u}}_{d}^{k - 2} + ( 1 - {λ}_{2} ) / {λ}_{2} Δ {u}_{d}^{k - 1}$$

where

$${T}_{s c}^{k - 2}$$

denotes the sampling interval of the control period at the sampling time k−2;

$${\hat{u}}_{d}^{k - 2}$$

denotes the observed value of the disturbance voltage at the sampling time k−2; λ₂ denotes the integral calculation gain of the disturbance voltage, and 0<λ₂<1.
S2, based on the estimated value of the disturbance voltage at the previous sampling time obtained by S1, the estimated value of the disturbance voltage at the current sampling time is calculated, and based on the estimated value of the disturbance voltage at the current sampling time, the observed value of the stator current of the synchronous motor at the next sampling time is predicted to compensate the digital delay;
in S2, the calculation formula of the estimated value

$${\hat{u}}_{d}^{k}$$

of the disturbance voltage at the current sampling time k is as follows:

$${\hat{u}}_{d}^{k} = {\hat{u}}_{d}^{k - 1} {e}^{j {ω}_{e} {T}_{s c}^{k - 1}}$$

the prediction calculation formula of the current observation value

$${\hat{i}}_{s}^{k + 1}$$

of the synchronous motor stator is as follows:

$${\hat{i}}_{s}^{k + 1} = {c}_{1}^{k} {\hat{i}}_{s}^{k} + {c}_{2}^{k} {u}_{s}^{k} - {c}_{3}^{k} ( {\hat{u}}_{d}^{k} + {E}_{d}^{k} ) - {λ}_{1} {e}^{j {ω}_{e} {T}_{s c}^{k}} Δ {i}_{s}^{k}$$

where

$${c}_{1}^{k} , {c}_{2}^{k} and {c}_{3}^{k}$$

denote the observer model parameters at the current sampling time K, and

$${c}_{1}^{k} = {e}^{- {T}_{s c}^{k} / {τ}_{s}} , \qquad {c}_{2}^{k} = ( 1 - {c}_{1}^{k} ) / {R}_{s} ; \qquad {E}_{d}^{k}$$

denotes the back electromotive force at the current sampling time k, and

$${E}_{d}^{k} = j {ω}_{e} {ψ}_{r} {e}^{j {θ}_{r}^{k}} , {θ}_{r}^{k}$$

denotes the measured value of the rotor position of the synchronous motor at the current sampling time k, and ψᵣ denotes the permanent magnet flux linkage of the synchronous motor rotor;

$${u}_{s}^{k}$$

denotes the voltage vector of the inverter output to the stator end of the motor at the current sampling time k;

$${T}_{s c}^{k}$$

denotes the sampling interval of the control period at the current sampling time k
S3, based on the observed value of the stator current of the synchronous motor at the next sampling time obtained by S2, the voltage drop of the stator winding of the synchronous motor at the next sampling time is calculated, and the observed value of the disturbance voltage at the next sampling time is calculated based on the estimated value of the disturbance voltage at the current sampling time obtained by S2;
in S3, the calculation formula for the voltage drop

$${u}_{i}^{k + 1}$$

of the stator winding of the synchronous motor at the sampling time k+1 is as follows:

$${u}_{i}^{k + 1} = {R}_{s} ( 1 + j {ω}_{e} {τ}_{s} ) {\hat{i}}_{s}^{k + 1}$$

the calculation formula of the observed value

$${\hat{u}}_{d}^{k + 1}$$

of the disturbance voltage at the sampling time k+1 is as follows:

$${\hat{u}}_{d}^{k + 1} = {\hat{u}}_{d}^{k} {e}^{j {ω}_{e} {T}_{s c}^{k}}$$

S4, based on the voltage drop and the observed value of the disturbance voltage of the stator winding of the synchronous motor at the next sampling time obtained by S3, the voltage command phase at the next sampling time is predicted, and the preset sampling position adjacent to the voltage command phase at the next sampling time is calculated, so that the motor command phase is mapped to the discrete sampling point preset by SSVM;
in S4, the prediction formula of the voltage command phase

$${θ}_{u 0}^{k + 1}$$

at the sampling time k+1 is as follows:

$${θ}_{ι ι 0}^{k + 1} = \frac{π}{6 N} + ∠ ( {u}_{i}^{k + 1} + {E}_{d}^{k + 1} + {\hat{u}}_{d}^{k + 1} )$$

where N denotes the count of sampling points in the [0-60°) sector of the selected synchronous modulation strategy;

$${E}_{d}^{k + 1}$$

denotes the back electromotive force at the sampling time k+1, and

$${E}_{d}^{k + 1} = {E}_{d}^{k} {e}^{j {ω}_{e} {T}_{s c}^{k}} ;$$

the calculation formula of a preset sampling position rᵤ is as follows:

$${r}_{u} = round ( 3 N ( {θ}_{u 0}^{k + 1} - {θ}_{0} ) / π )$$

where round( ) denotes rounding to a nearest integer; θ₀ denotes the first sampling position of the synchronous modulation strategy in the [0-60°) sector.
S5, based on the voltage instruction phase calculated by S4 and the preset sampling position, the sampling interval of the control period of the next sampling time is calculated, so that the voltage instruction can align the sampling points of SSVM by adjusting the control period to avoid phase deviation;
the calculation formula of the sampling interval

$${T}_{s c}^{k + 1}$$

of the control period in S5 is as follows:

$${T}_{s c}^{k + 1} = \frac{π}{3 N {ω}_{e}} + \frac{{r}_{ι ι} π / ( 3 N ) + {θ}_{0} - {θ}_{ι ι 0}^{k + 1}}{{ω}_{e}}$$

S6, the voltage command is generated by the sampling interval of the control period at the next sampling time calculated based on S5;
the generation formula of the voltage instruction

$${u}_{s}^{r e f}$$

described in S6 is as follows:

$${u}_{s}^{r e f} = \frac{1}{{c}_{2}^{k + 1}} \{ {i}_{s}^{r e f} - {c}_{1}^{k + 1} {\hat{i}}_{s}^{k + 1} + {c}_{3}^{k + 1} ( {E}_{d}^{k} + {\hat{u}}_{d}^{k} ) {e}^{j {ω}_{e} {T}_{s c}^{k}} \} ;$$

where

$${c}_{1}^{k + 1} , {c}_{2}^{k + 1} , and {c}_{3}^{k + 1}$$

denote the observer model parameters at the sampling time k+1;

$${i}_{s}^{r e f}$$

denotes the stator current reference value, and

$${i}_{s}^{r e f} = ( {i}_{d}^{r e f} + j {i}_{q}^{r e f} ) {e}^{j ( {θ}_{r}^{k} + {ω}_{e} {T}_{s c}^{k} + {ω}_{e} {T}_{s c}^{k + 1} )} , {i}_{d}^{r e f}$$

denotes the excitation current instruction,

$${i}_{q}^{r e f}$$

denotes the torque current instruction.
S7, based on the voltage command obtained by S6, the duty ratio of each basic voltage vector is calculated to obtain an SSVM pulse.

The calculation formula of the duty ratio for each basic voltage vector in S7 is as follows:

$$\{ \begin{matrix}dx = M sin ( π / 3 - ∠ {u}_{s}^{r e f} ) \\ d y = M sin ( ∠ {u}_{s}^{r e f} ) \\ {d}_{0} = 1 - d x - d y\end{matrix}$$

where dx and dy denote the duty ratios of mm two effective voltage vectors respectively; M denotes the modulation ratio, and

$$M = \sqrt{3} \vert {u}_{s}^{ref} \vert / {u}_{dc} , {u}_{dc}$$

denotes the measured value of DC bus voltage;

$$∠ {u}_{s}^{ref}$$

denotes the phase angle of the voltage command

$${u}_{s}^{ref} ;$$

d₀ denotes the duty ratio of the zero vector.

### Simulation and Experiment Tests

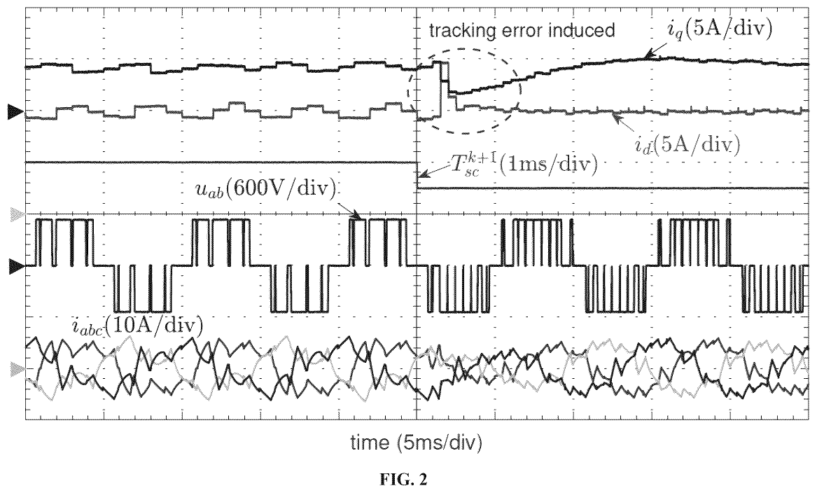

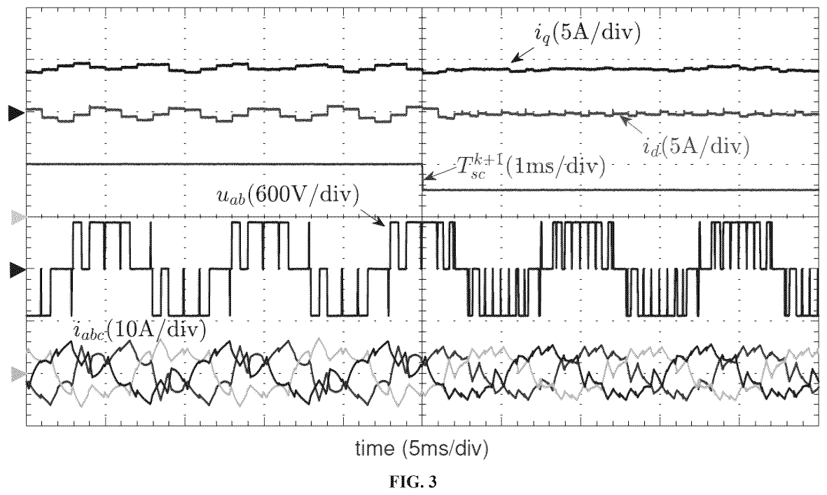

The method described in the invention is compared with the traditional deadbeat predictive current control method, and the sampling step sudden change experiment, harmonic suppression experiment, torque step response experiment, and parameter robustness experiment are carried out respectively, the results of the sampling step sudden change experiment are shown in FIG. 2 and FIG. 3, it can be seen that the traditional deadbeat predictive current control will lead to transient current tracking error when the sampling step sudden change occurs, while the technical scheme of the invention can still maintain good control performance when the sampling step sudden change occurs.

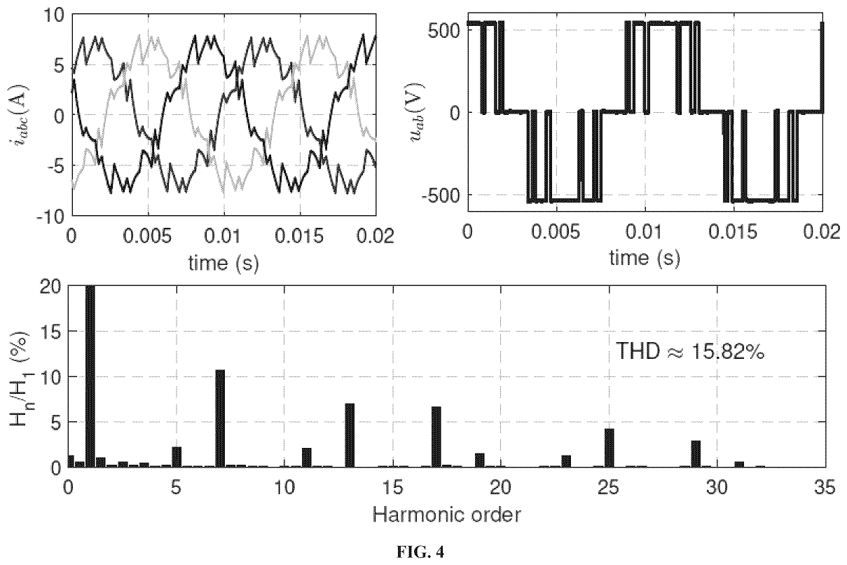

The experimental results of harmonic suppression are shown in FIG. 4, in the steady state, the phase voltage waveform of the motor is symmetrical, and the stator current has no obvious fractional and even harmonics, indicating that the technical scheme of the invention can better reproduce the low current harmonic characteristics of the synchronous space vector modulation in the quasi-steady state operation.

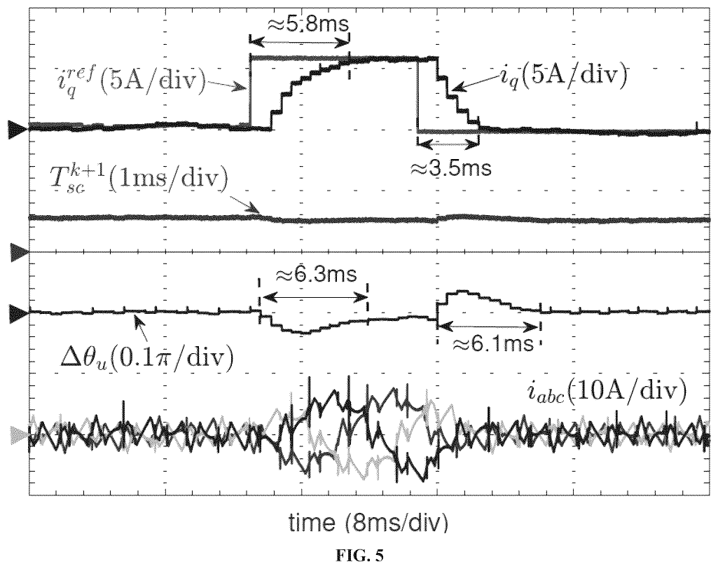

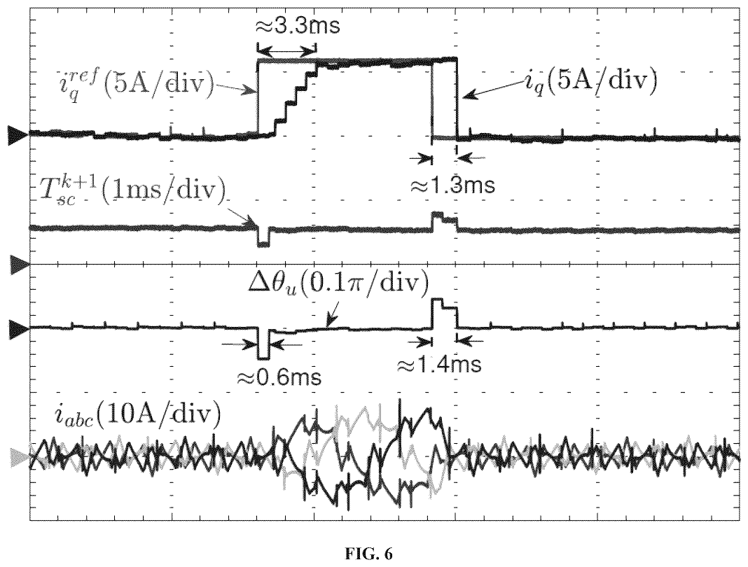

The experimental results of the torque step response are shown in FIG. 5 and FIG. 6, it takes about 5.8 ms and 3.5 ms for the traditional vector control to achieve the new steady state when the torque command increases and decreases suddenly, respectively, while the technical scheme of the invention only needs 3.3 ms and 1.3 ms under the same test conditions. In addition, it can be seen from the phase synchronization error that the technical scheme of the invention can eliminate the synchronization error in only 1.4 ms at most, while the traditional vector control takes more than 6 ms under the same test conditions.

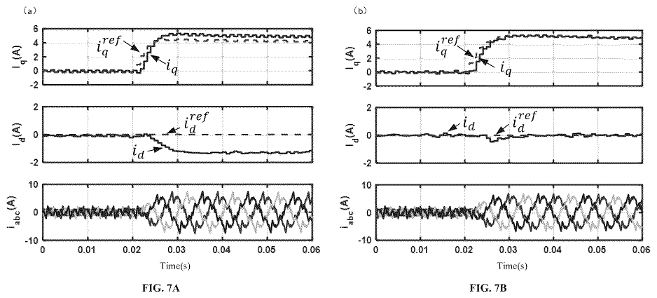

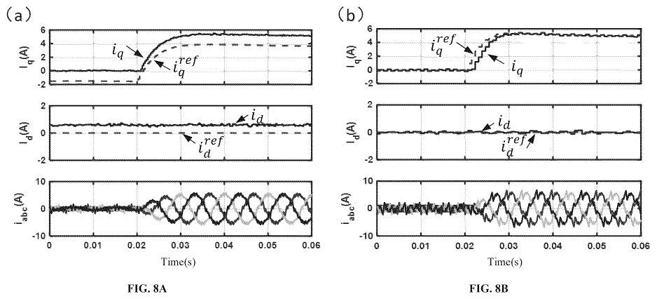

The experimental results of parameter robustness are shown in FIGS. 7A-7B and FIGS. 8A-8B, when there is no disturbance compensation, the current has a steady-state error, after the disturbance compensation is enabled, the error is significantly suppressed, and stable tracking is maintained.

The above test results verify that the technology of the invention has a faster current tracking response and phase synchronization speed than the traditional technical scheme, thus proving the effectiveness of the invention.

Finally, it should be explained that the above embodiments are only used to explain the technical scheme of the invention rather than restrict it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A robust predictive current control method for a synchronous motor with synchronous space vector modulation, comprising the following steps:
S1, according to a current observation error at a current sampling time, estimating a disturbance voltage deviation, and updating an estimated value of a disturbance voltage at a previous sampling time based on the disturbance voltage deviation;
S2, based on the estimated value of the disturbance voltage at the previous sampling time obtained by S1, calculating the estimated value of the disturbance voltage at the current sampling time, and based on the estimated value of the disturbance voltage at the current sampling time, predicting an observed value of a stator current of the synchronous motor at a next sampling time to compensate a digital delay;
S3, based on the observed value of the stator current of the synchronous motor at the next sampling time obtained by S2, calculating a voltage drop of a stator winding of the synchronous motor at the next sampling time, and calculating an observed value of the disturbance voltage at the next sampling time based on the estimated value of the disturbance voltage at the current sampling time obtained by S2;
S4, based on the voltage drop and the observed value of the disturbance voltage of the stator winding of the synchronous motor at the next sampling time obtained by S3, predicting a voltage command phase at the next sampling time, and calculating a preset sampling position adjacent to the voltage command phase at the next sampling time, so that a motor command phase is mapped to a discrete sampling point preset by synchronous space vector modulation (SSVM);
S5, based on the voltage command phase calculated by S4 and the preset sampling position, calculating a sampling interval of a next control period, so that the voltage command phase is aligned with sampling points of SSVM by adjusting the control period to avoid phase deviation;
S6, generating a voltage command based on the sampling interval of the next control period calculated based on S5; and
S7, based on the voltage command obtained by S6, calculating a duty ratio of each basic voltage vector to obtain SSVM pulses.

2. The robust predictive current control method according to claim 1, wherein in S1, an estimation formula of the disturbance voltage deviation is:
$$Δ {u}_{d}^{k - 1} = ( {λ}_{1} {e}^{j {ω}_{e} {T}_{sc}^{k - 1}} Δ {i}_{s}^{k - 1} - Δ {i}_{s}^{k} ) / {c}_{3}^{k - 1}$$
wherein
$$Δ {u}_{d}^{k - 1}$$
denotes a disturbance voltage deviation at a sampling time k−1; λ₁ denotes an error feedback gain of an observer; j denotes an imaginary unit;
$${T}_{sc}^{k - 1}$$
denotes a sampling interval at the sampling time k−1; ωₑ denotes an electrical speed of a synchronous motor rotor;
$$Δ {i}_{S}^{k - 1} and Δ {i}_{S}^{k}$$
denote current observation errors at the sampling time k−1 and a current sampling time k respectively, and
$$Δ {i}_{S}^{k} = {i}_{S}^{k} - {\hat{i}}_{S}^{k} , {i}_{S}^{k}$$
denotes a stator current value of the synchronous motor at the current sampling time k measured by a current sensor, and
$${\hat{i}}_{S}^{k}$$
denotes a stator current value of the synchronous motor at the current sampling time k observed by the observer;
$${c}_{3}^{k - 1}$$
denotes an observer model parameter at the sampling time k−1;
wherein
$${c}_{3}^{k - 1} = \frac{{e}^{j {ω}_{e} {T}_{sc}^{k - 1}} - {e}^{- {T}_{sc}^{k - 1} / {τ}_{s}}}{{R}_{s} ( 1 + j {ω}_{e} {τ}_{s} )} ;$$
wherein Rₛ denotes a nominal value of a stator resistance of the synchronous motor; τₛ denotes a nominal value of a stator time constant of the synchronous motor;
an updated calculation formula of the estimated value
$${\hat{u}}_{d}^{k - 1}$$
of the disturbance voltage is as follows:
$${\hat{u}}_{d}^{k - 1} = {e}^{j {ω}_{e} {T}_{sc}^{k - 2}} {\hat{u}}_{d}^{k - 2} + ( 1 - {λ}_{2} ) / {λ}_{2} Δ {u}_{d}^{k - 1} ;$$
wherein
$${T}_{sc}^{k - 2}$$
denotes a sampling interval of the control period at a sampling time k−2;
$${\hat{u}}_{d}^{k - 2}$$
denotes an observed value of the disturbance voltage at the sampling time k−2; and λ₂ denotes an integral calculation gain of the disturbance voltage, and 0<λ₂<1.

3. The robust predictive current control method according to claim 2, wherein in S2, a calculation formula of the estimated value
$${\hat{u}}_{d}^{k}$$
of the disturbance voltage at the current sampling time k is as follows:
$${\hat{u}}_{d}^{k} = {\hat{u}}_{d}^{k - 1} {e}^{j {ω}_{e} {T}_{sc}^{k - 1}} ;$$
a prediction calculation formula of the observed value
$${\hat{i}}_{s}^{k + 1}$$
of the stator current of the synchronous motor is as follows:
$${\hat{i}}_{s}^{k + 1} = {c}_{1}^{k} {\hat{i}}_{s}^{k} + {c}_{2}^{k} {u}_{s}^{k} - {c}_{3}^{k} ( {\hat{u}}_{d}^{k} + {E}_{d}^{k} ) - {λ}_{1} {e}^{j {ω}_{e} {T}_{sc}^{k}} Δ {i}_{s}^{k} ;$$
wherein
$${c}_{1}^{k} , {c}_{2}^{k} and {c}_{3}^{k}$$
denote observer model parameters at the current sampling time k, and
$${c}_{1}^{k} = {e}^{- {T}_{sc}^{k} / {τ}_{s}} , {c}_{2}^{k} = ( 1 - {c}_{1}^{k} ) / {R}_{s} ; {E}_{d}^{k}$$
denotes a back electromotive force at the current sampling time k, and
$${E}_{d}^{k} = j {ω}_{e} {ψ}_{r} {e}^{j {θ}_{r}^{k}} , {θ}_{r}^{k}$$
denotes measured values of a rotor position of the synchronous motor at the current sampling time k, and ωᵣ denotes a permanent magnet flux linkage of the synchronous motor rotor;
$${u}_{s}^{k}$$
denotes a voltage vector of an inverter output to a stator end of the synchronous motor at the current sampling time k; and
$${T}_{sc}^{k}$$
denotes a sampling interval of the control period at the current sampling time k.

4. The robust predictive current control method according to claim 3, wherein in S3, a calculation formula for the voltage drop
$${u}_{i}^{k + 1}$$
of the stator winding of the synchronous motor at the sampling time k+1 is as follows:
$${u}_{i}^{k + 1} = {R}_{s} ( 1 + j {ω}_{e} {τ}_{s} ) {\hat{i}}_{s}^{k + 1} ;$$
a calculation formula of the observed value
$${\hat{u}}_{d}^{k + 1}$$
of the disturbance voltage at the sampling time k+1 is as follows:
$${\hat{u}}_{d}^{k + 1} = {\hat{u}}_{d}^{k + 1} {e}^{j {ω}_{e} {T}_{sc}^{k}} .$$

5. The robust predictive current control method according to claim 4, wherein in S4, a prediction formula of the voltage command phase
$${θ}_{u 0}^{k + 1}$$
at the sampling time k+1 is as follows:
$${θ}_{u 0}^{k + 1} = \frac{π}{6 N} + ∠ ( {u}_{i}^{k + 1} + {E}_{d}^{k + 1} + {\hat{u}}_{d}^{k + 1} ) ;$$
wherein N denotes a count of sampling points in a [0-60°) sector of a selected synchronous modulation strategy; and
$${E}_{d}^{k + 1}$$
denotes a back electromotive force at the sampling time k+1, and
$${E}_{d}^{k + 1} = {E}_{d}^{k} {e}^{j {ω}_{e} {T}_{sc}^{k}} ;$$
a calculation formula of a preset sampling position rᵤ is as follows:
$${r}_{u} = round ( 3 N ( {θ}_{u 0}^{k + 1} - {θ}_{0} ) / π ) ;$$
wherein round( ) denotes rounding to a nearest integer; and θ₀ denotes a first sampling position of the selected synchronous modulation strategy in the [0-60°) sector.

6. The robust predictive current control method according to claim 5, wherein a calculation formula of the sampling interval
$${T}_{sc}^{k + 1}$$
of the control period in S5 is as follows:
$${T}_{sc}^{k + 1} = \frac{π}{3 N {ω}_{e}} + \frac{{r}_{u} π / ( 3 N ) + {θ}_{0} - {θ}_{u 0}^{k + 1}}{{ω}_{e}} .$$

7. The robust predictive current control method according to claim 6, wherein a generation formula of a voltage instruction
$${u}_{s}^{ref}$$
described in S6 is as follows:
$${u}_{s}^{ref} = \frac{1}{{c}_{2}^{k + 1}} \{ {i}_{s}^{ref} - {c}_{1}^{k + 1} {\hat{i}}_{s}^{k + 1} + {c}_{3}^{k + 1} ( {E}_{d}^{k} + {\hat{u}}_{d}^{k} ) {e}^{j {ω}_{e} {T}_{sc}^{k}} \} ;$$
wherein
$${c}_{1}^{k + 1} , {c}_{2}^{k + 1} and {c}_{3}^{k + 1}$$
denote observer model parameters at the sampling time k+1;
$${i}_{s}^{ref}$$
denotes a stator current reference value, and
$${i}_{s}^{ref} = ( {i}_{d}^{ref} + {ji}_{q}^{ref} ) {e}^{j ( {θ}_{r}^{k} + {ω}_{e} {T}_{sc}^{k} + {ω}_{e} {T}_{sc}^{k + 1} )} , {i}_{d}^{ref}$$
denotes an excitation current instruction, and
$${i}_{q}^{ref}$$
denotes a torque current instruction.

8. The robust predictive current control method according to claim 6, wherein in S7, a calculation formula of the duty ratio for each basic voltage vector is as follows:
$$\{ \begin{matrix}dx = M sin ( π / 3 - ∠ {u}_{s}^{ref} ) \\ dy = M sin ( ∠ {u}_{s}^{ref} ) \\ {d}_{0} = 1 - dx - dy\end{matrix} ;$$
wherein dx and dy denote the duty ratios of two effective voltage vectors respectively; M denotes a modulation ratio, and
$$M = \sqrt{3} \vert {u}_{s}^{ref} \vert / {u}_{dc} , {u}_{dc}$$
denotes a measured value of direct current (DC) bus voltage;
$$∠ {u}_{s}^{ref}$$
denotes a phase angle of a voltage command
$${u}_{s}^{ref} ;$$
and d₀ denotes a duty ratio of a zero vector.
